(19) United States
(12) Patent Application Publication
(10) Pub. No.: US 2007/0179882 A1
(43) Pub. Date: Aug. 2, 2007

(54) Method of increasing cash flow for a not-for-profit entity

(75) Inventor: Richard Intrator, New York, NY (US)

Correspondence Address: George C. Chen;Bryan Cave LLP, Suite 2200, Two North Central Avenue, Phoenix, AZ, 85004-4406, US

(73) Assignee: Philanthria, LLC, New York, NY (US)

(21) Appl. No.: 11/341,296

(22) Filed: Jan. 27, 2006

(51) Int. Cl. G06Q 40/00

(52) U.S. Cl. 705/38

(57) ABSTRACT

A method of increasing cash flow for a not-for-profit entity (201) includes: (a) pledging a donation amount as collateral for a loan amount while the donation amount remains unrealized by the not-for-profit entity; (b) investing the loan amount at an investment rate greater than a lending rate for the loan amount; and (c) pledging the invested loan amount as additional collateral for the loan amount.

### FIELD OF THE INVENTION

This invention relates generally to increasing cash flow for not-for-profit institutions, and relates more particularly to pledging existing and/or future bequests as collateral to increase cash flow for not-for-profit institutions.

### BACKGROUND OF THE INVENTION

Eleemosynary donations are a big business in the United States. For example, in 2002, eleemosynary donations in the United States totaled approximately $240 billion. Additionally, during that same time, some estimates indicated that another $200 billion in donations resided off the balance sheets of not-for-profit and non-profit entities such as charities and other philanthropic entities. Despite the large cumulative donations, many entities that rely upon such donations for operating income often have cash flow problems.

As an example of a situation during which such problems may occur, a charity may know that a particular benefactor or donor will give a donation to the charity upon his death. The charity will not know, however, when the benefactor will die, and consequently, the charity will also not know when it will receive the donation. In such instances, the charity may have cash flow problems during a ten year or more “dry spell” if the charity receives very few other donations or, even worse, does not receive any donations at all during that time.

Another situation during which a charity may have cash flow problems occurs if the charity relies primarily upon benefactors or donors that are business entities operating on a calendar tax basis. In this example, the charity might have an eleven month “dry spell” during which time the charity does not receive any sizable donations.

To improve the cash flow of these not-for-profit and non-profit entities, the management and boards of directors for such entities have focused their attention on raising more donations and other funds through additional eleemosynary contributions. Management and directors have also attempted to reduce costs through budget controls and other techniques. None of these attempts, however, have solved the insufficient cash flow problem for not-for-profit and non-profit entities.

Finally, management and directors have also attempted to obtain loans and other financing from banks and other lenders. The banks and other lenders, however, still have not solved the cash flow problem because the not-for-profit and non-profit entities often do not have enough conventional collateral to pledge to the lenders as security for the loan.

Accordingly, a need still exists for a method of increasing the cash flow of charities and other not-for-profit and non-profit entities.

### BRIEF DESCRIPTION OF THE DRAWINGS

The invention will be better understood from a reading of the following detailed description, taken in conjunction with the accompanying figures in the drawings in which:

FIG. 1 is a graphical representation of an actual endowment transaction compared to a Synthetic Endowment™ transaction for increasing cash flow for a not-for-profit entity in accordance with an embodiment of the present invention;

FIG. 2 is a block diagram of a first method of increasing cash flow for a not-for-profit entity in accordance with an embodiment of the present invention;

FIG. 3 is a block diagram of a second method of increasing cash flow for a not-for-profit entity in accordance with a different embodiment of the present invention;

FIG. 4 is a block diagram of a third method of increasing cash flow for a not-for-profit entity in accordance with another embodiment of the present invention;

FIG. 5 is a block diagram of a fourth method of increasing cash flow for a not-for-profit entity in accordance with yet another embodiment of the present invention;

FIGS. 6a and 6b are a flow chart of a method of increasing cash flow for a not-for-profit entity, from the perspective of the not-for-profit entity, in accordance with an embodiment of the present invention;

FIGS. 7a and 7b are a flow chart of a method of increasing cash flow for a not-for-profit entity, from the perspective of a lender, in accordance with an embodiment of the present invention; and

FIGS. 8a and 8b are a flow chart of a method of increasing cash flow for a not-for-profit entity, from the perspective of an intermediary between the not-for-profit entity and a lender, in accordance with an embodiment of the present invention.

The terms “first,” “second,” “third,” “fourth,” and the like in the Detailed Description of Exemplary Embodiments and in the Claims are used for distinguishing between similar elements and not necessarily for describing a particular sequential or chronological order. The terms so used are interchangeable under appropriate circumstances such that the embodiments of the invention described herein are, for example, capable of operation in sequences other than those illustrated or otherwise described herein.

### DETAILED DESCRIPTION OF EXEMPLARY EMBODIMENTS

Generally, in accordance with an embodiment of the invention, a method of increasing the cash flow for a not-for-profit entity can bring cash forward, or immediately unlock large cash values, by monetizing intangible assets. More specifically, the method can create new cash flow and/or can create current liquidity from intangible assets that currently lie dormant on and off the-not-for-profit entity's balance sheet without sacrificing the entity's ability to collect or receive such intangible assets in the future.

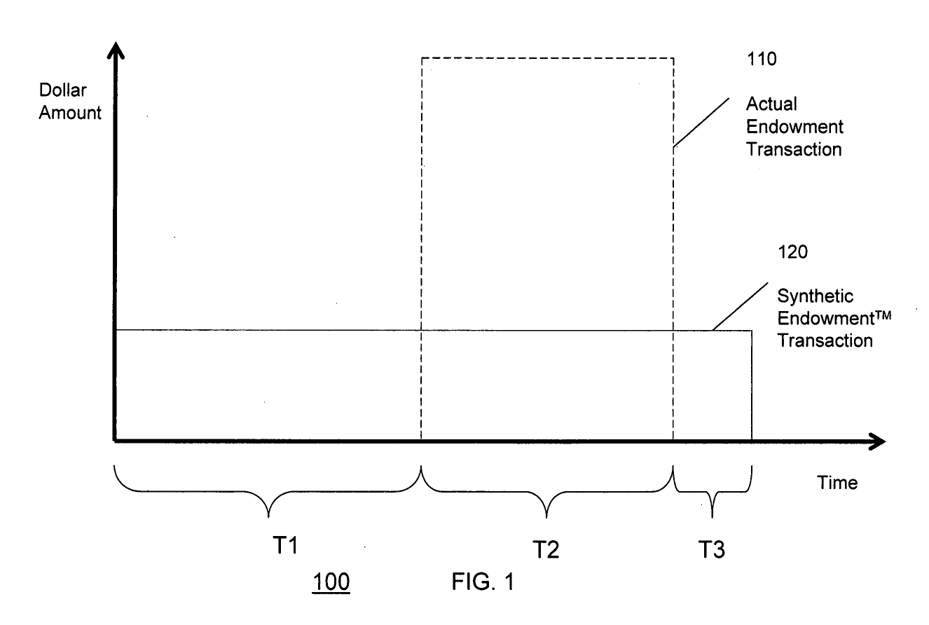

As an example, the method smooths out, spreads out, or more evenly distributes the donation amounts given to a not-for-profit entity to provide more predictable and steady annual cash flow or operating cash flow to facilitate planning and operations. This advantage is depicted in FIG. 1 where an actual endowment transaction 110 by illustrated by dashed lines and where a Synthetic Endowment™ transaction 120 provided by an embodiment of the present method is illustrated by a solid line. Without Synthetic Endowment™ transaction 120 and relying on actual donations alone (i.e., actual endowment transaction 110), the not-for-profit entity would not receive any donations during time T1 for at least the reasons explained in the Background of the Invention. Also during this time T1, the not-for-profit entity would not have any cash flow or operating income. During time T2, the not-for-profit entity would receive donations and would have cash flow or operating income, but during time T3, the not-for-profit would, again, not receive any donations. However, as also depicted in FIG. 1, when the not-for-profit uses the Synthetic Endowment™ transaction described herein, it has cash flow and operating income during each of times T1, T2, and T3, which smooths out the cash flow and operating income for the not-for-profit entity. Consequently, Synthetic Endowment™ transaction 120 increases the cash flow and operating income for the not-for-profit entity at least during times T1 and T3 as compared to relying on only actual endowments.

A broad overview of an embodiment of the method includes the following three steps when viewed from the perspective of a not-for-profit entity. The first step monetizes the intangible assets. As an example, the first step can include pledging or otherwise providing unrealized donation amounts as collateral to a lender. The lender can use the unrealized donation amounts as security for an initial borrowing base, or loan amount, granted to the not-for-profit entity. As an example, the lender can be a bank or other financial institution, another business entity, or even an individual person. As used herein, the term “not-for-profit entity,” in its singular or plural form, includes not-for-profit entities, non-profit entities, charities, museums, social service agencies, zoos, foundations, universities, colleges and other schools, and other philanthropic entities.

The second step of the method includes investing the funds from the borrowing base, or loan amount, at one or more investments rates that are greater than the cost of borrowing. The investment rate(s) can be part of a safe and responsible investment structure that uses an arbitrage, employs stop losses, and/or otherwise assures preservation of the investment capital. The arbitrage is a difference between the investment rate and the cost of borrowing, or the borrowing rate or the loan's interest rate. Also, the arbitrage can be fixed, or it may vary over time. The arbitrage represents the not-for-profit entity's earnings on a Synthetic Endowment™ transaction provided by the lender's loan. The not-for-profit entity can use these earnings from the Synthetic Endowment™ transaction to increase its cash flow. As an example, the not-for-profit entity can use the earnings as operating income and for philanthropic purposes.

The third step of the method includes using the invested funds as a second form of collateral for the loan from the lender. To minimize its risk, the lender can use this second form of collateral as additional security for the loan that it granted to the not-for-profit entity.

By using the above-described method, the not-for-profit entity uses its unrealized donation amounts in several advantageous ways. For example, the not-for-profit entity can use two forms of one hundred percent collateralization for its loan from a lender. The loan creates liquidity from the not-for-profit entity's unrealized donation amounts and provides new incremental cash flow to the entity. From the lender's perspective, this dual collateralization structure for the Synthetic Endowment™ transaction is different from and reduces the risk associated with conventional financial leverage that uses a single collateralization structure. Using the present method also reduces the risk for the not-for-profit entity by locking in an arbitrage and using self-liquidating assets.

Additionally, the not-for-profit entity pumps up, or increases, its actual endowment to provide large amounts of immediate cash for special purposes or greater financial security. The method provides the not-for-profit entity with current incremental cash from future commitments, thereby compounding the amount of raised funds and the productivity of development or fund-raising personnel. The not-for-profit entity can also use its Synthetic Endowment™ transaction to accelerate incremental earnings from currently intangible assets that the non-for-profit entity will eventually receive, but that are currently lying idle and unproductive.

This method is different from conventional techniques for increasing cash flow for not-for-profit entities because, in the past, banks and other lenders have not focused on the not-for-profit entities in terms of maximizing balance sheets and addressing working capital needs and opportunities, as the present method does. For example, this method is different from conventional asset-based financing, also called a structured financing or asset securitization, which provides security through single or pooled accounts receivables. A reason for the difference is because the present method can provide security for the financing from unrealized donation amounts before the donation amounts can be considered as an account receivable because the unrealized donation amounts are considered off of the not-for-profit entity's balance sheet. Similarly, the present method provides a Synthetic Endowment™ transaction that creates liquidity from idle assets to create new cash flow while conventional leveraged endowments merely enhance returns from existing assets. In one embodiment, the Synthetic Endowment™ transaction does not mortgage or sell off the collateral.

As another example, this method is also different from other investment and lending structures that minimize risk by creating separate legal entities or special purpose entities to independently own and control various pooled assets. A reason for the difference is because the present method does not need to create any separate legal entities or special purposes entities. Instead, the originally existing entities own and control the collateral and investments.

Additional reasons as to how the present method minimizes more risk than conventional investment and lending structures such as leveraged endowments are: (1) the present method mitigates poor investment performance by fixing an arbitrage spread or employing stop losses, while leveraged endowments can create disproportionate loss versus return (loss) on the actual investment; and (2) to the extent that a loss is possible, the present method covers the loss by over collateralization attributed to assets yet to be realized by the not-for-profit entity so that there is no reduction of the current endowment, while leveraged endowment or losses permanently reduce existing endowment assets.

The present method is also different from conventional factoring or other selling of future revenue as used in the film industry where several identified motion pictures that are to be cast, filmed, and produced are pooled together and used collectively as collateral for a loan. A reason for the difference is because the not-for-profit entity's future revenue is unrealized, unknown, and unpredictable because the future revenue can include revocable and/or irrevocable future donations.

Finally, the present method is also different from leveraged endowments when viewed from the perspective of the impact on the operations of the not-for-profit entity. In particular, the present invention increases the incremental current yield from development personnel while conventional leveraged endowment techniques do not provide such an incremental yield. The present method is also different in that both sides of the transaction (i.e., the lender and the borrower) are protected because: (1) the lender holds financial assets that are liquid and marketable without being dependent upon the actual future donations that the borrower receives; and (2) the borrower also holds the financial assets that are liquid and marketable and where the financial assets have stop loss provisions and/or a fixed arbitrage. In this manner, even if the borrower does not realize its expected future donations, the unwinding of the transaction protects both the lender and the borrower.

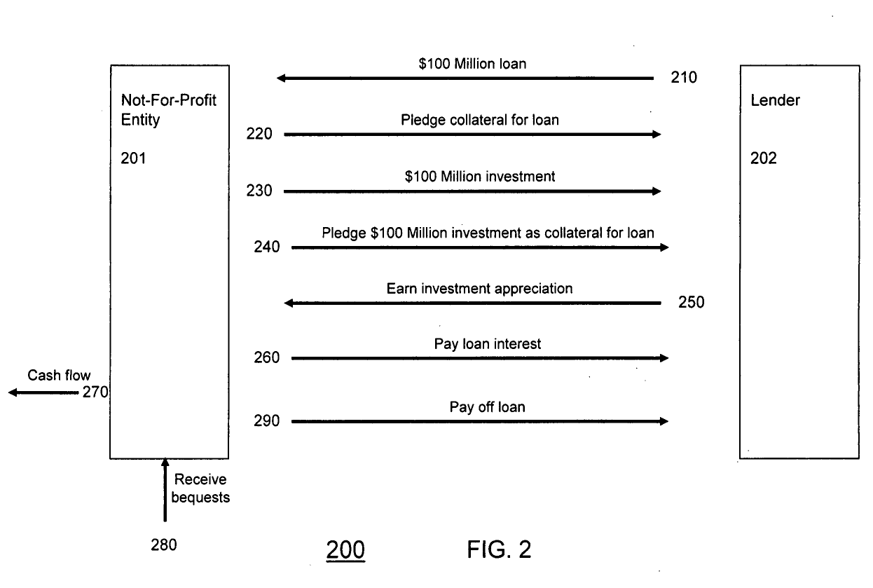

Turning to FIG. 2, a block diagram 200 represents an embodiment of a method of increasing the cash flow for a not-for-profit entity 201. Generally, the block diagram illustrates the conversion of yet-to-be-received endowments into liquid money market equivalents to serve as an internal or external revolving credit line for the operations of entity 201. Specifically referring to the embodiment of FIG. 2, entity 201 borrows $100 million from a lender 202, as indicated by an arrow 210. As an example, if the loan that the entity 201 borrows from lender 202 is at a borrowing rate of 4.25% per annum, then entity 201 pays $4.25 million in interest for each year that it has the loan with lender 202. In some embodiments, lender 202 can provide a multi-year loan to entity 201 with short term or long term windows to temporarily unwind the loan based on investment strategy, investment market conditions, and/or stability of invested capital. An example of a short term window includes a ninety-day loan with options to renew.

As also depicted in FIG. 2 by an arrow 220, entity 201 pledges or otherwise provides short-term and/or long-term bequests as collateral or security for the $100 million loan. As an example, entity 201 can assign $100 million in future cash flow to lender 202. As a different example, entity 201 can assign more than $100 million in future cash flow to lender 202 so that the size of the collateral is in excess of the borrowed $100 million. Lender 202 and entity 201 can negotiate a loan-to-collateral ratio, but the ratio can be relatively high (e.g., fifty percent to ninety percent) compared to the ratios used in conventional financing techniques due to the dual collateralization discussed in more detail below.

The bequests that are pledged as collateral represent an unidentified and intangible income stream that entity 201 expects based on historical donations, and such bequests can include pledges, legacies, endowments, and wills and can be for cash, stocks, real estate, automobiles, airplanes, paintings, sculptures, and/or other items of value. The bequests that are pledged as collateral can include future bequests that, as an example, are not specifically identified by donor, amount, time, or even type. The bequests that are pledged as collateral can also include revocable and non-revocable existing bequests, or both future bequests and existing bequests. As an example of an existing bequest, entity 201 may approach its directors or other third parties for long-term revocable or irrevocable bequest commitments. The bequests are pooled together as collateral for lender 202. The pooling diversifies risk and reduces the need to monitor each underlying payment stream.

Entity 201 would consider future bequests as off balance sheet items due to their unpredictability. Entity 201 may consider existing bequests as on balance sheet items, particularly when the size or amount of the bequest and its payment date is known. However, entity 201 may also consider existing bequests as off balance sheet items, particularly if the bequests are revocable. Regardless of whether the bequests are on or off balance sheet items, the bequests are unrealized by entity 201 when it pledges them as collateral to lender 202 because entity 201 has not received the bequests at that time.

In one embodiment, entity 201 pledges only long-term bequests that are at least one year away. The length of time during which the bequests received by entity 201 are considered collateral by lender 202, or the number of bequests received by entity 201 during a period of time that are considered collateral by lender 202, is determined by the size, frequency, and regularity of past bequests received by entity 201.

After borrowing the $100 million from lender 202, entity 201 invests the same $100 million with lender 202, as indicated by an arrow 230 in FIG. 2. Lender 202 can receive the $100 million and invest it in one of its investment accounts created for entity 201, subject to entity 201's investment guidelines. In one embodiment, lender 202 can investment the $100 million in an investment fund comprised of stocks, bonds, and/or real estate. As an example, if the investment account has a target investment rate or annual net yield of 5% to 8%, then entity 201 earns $5 million to $8 million per year in investment appreciation from its $100 million investment, as indicated by an arrow 250. In this embodiment, the $100 million loan that lender 202 lends to entity 201 does not leave lender 202 so lender 202's risk is minimized even further. In a different embodiment, lender 202 can receive the $100 million and invest it with a third party for the benefit of entity 201.

Entity 201 pledges or otherwise provides the $100 million investment account as collateral or security for the $100 million loan, as indicated by an arrow 240. In many situations, lender 202 would prefer to have the lien or security interest on the investment account as opposed to a lien or security interest on entity 201 itself or on the unrealized donation amounts or bequests to be received by entity 201. In the present method, however, lender 202 has dual 100% collateralization with liens on both the investment account and the unrealized donation amounts or bequests, as represented by arrows 220 and 240 in FIG. 2.

After using the $5 million to $8 million per year to pay off the $4.25 million per year in interest for the loan, as indicated by an arrow 260 in FIG. 2, entity 201 has $0.75 to $3.75 million per year remaining as increased cash flow that it can use as operating income, as indicated by an arrow 270 in FIG. 2. With the investment rate being higher than the loan rate, entity 201 puts its bequests to work before their scheduled or unscheduled payments occur by locking in a positive rate arbitrage to create a Synthetic Endowment™ transaction to increase its cash flow. The actions represented by arrows 250, 260, and 270 represent a rate arbitrage, as discussed above.

When entity 201 receives the bequests, as indicated by an arrow 280 in FIG. 2, entity 201 realizes the bequests, places them on its balance sheet, and pays off the loan in a piecemeal manner, as indicated by an arrow 290 in FIG. 2. In this embodiment, the collateral is self-liquidating. Entity 201 can also use other methods to pay off the loan.

In one embodiment, entity 201 has a long history of turning bequests into cash. Although the average amount of bequests realized by entity 201 over time may be steady, the amount of bequests turned into cash in any given year is volatile. Consequently, the cash flow problem that entity 201 had prior to using the present method is not due to its poor credit history, but instead is due to a timing issue. In a different embodiment where entity 201 does have a poor credit history, entity 201 can still use present method.

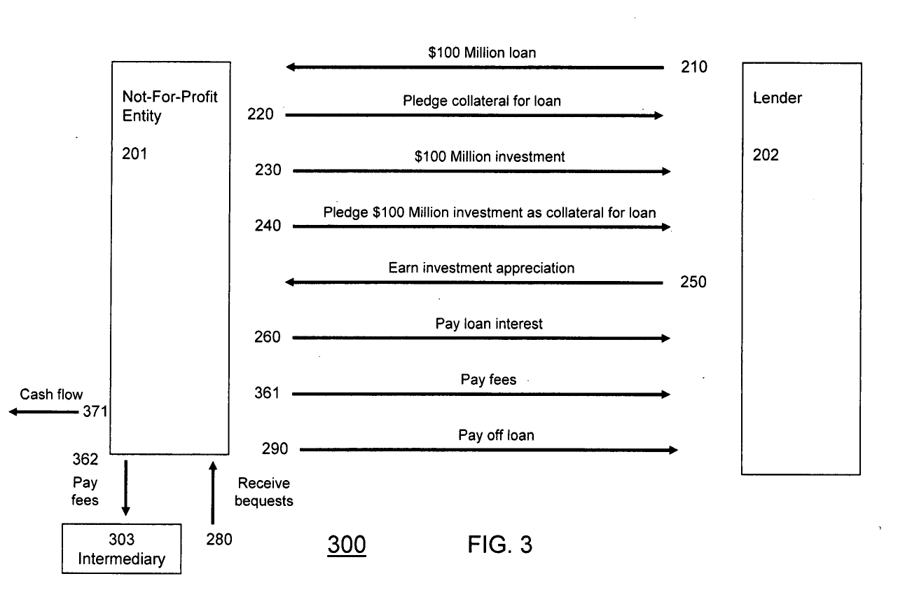

In some embodiments of the present method, as depicted by a block diagram 300 in FIG. 3, entity 201 uses a portion of the earned investment appreciation to pay other fees, in addition to the interest, to lender 202, as indicated by an arrow 361. Additionally, as indicated by an arrow 362, entity 201 can use another portion of earned investment income to pay other fees to a third party such as an intermediary 303 that coordinates or structures the presently described business relationship between entity 201 and lender 202. Entity 202 uses the remaining portion of the earned investment appreciation as its increased cash flow, as indicated by an arrow 371. In different embodiments of block diagram 300, step 361 is eliminated, and/or step 362 is eliminated. When performed, the actions represented by arrows 250, 260, 361, 362, and 371 represent the aforementioned rate arbitrage.

In the embodiments of FIGS. 2 and 3, the Synthetic Endowment™ transaction provides liquidity for entity 201 and is not used to provide operating financial leverage. For example, entity 201 does not dip into the $100 million in borrowed funds to enhance returns through leverage. Instead, entity 201 keeps all of the $100 million intact and focuses only on the earnings or investment appreciation provided from the liquidity, which lowers the risk for entity 201 and lender 202. This method creates new forms of returns by providing liquidity, and earnings thereon, to intangible assets that will be coming to entity 201 in future years.

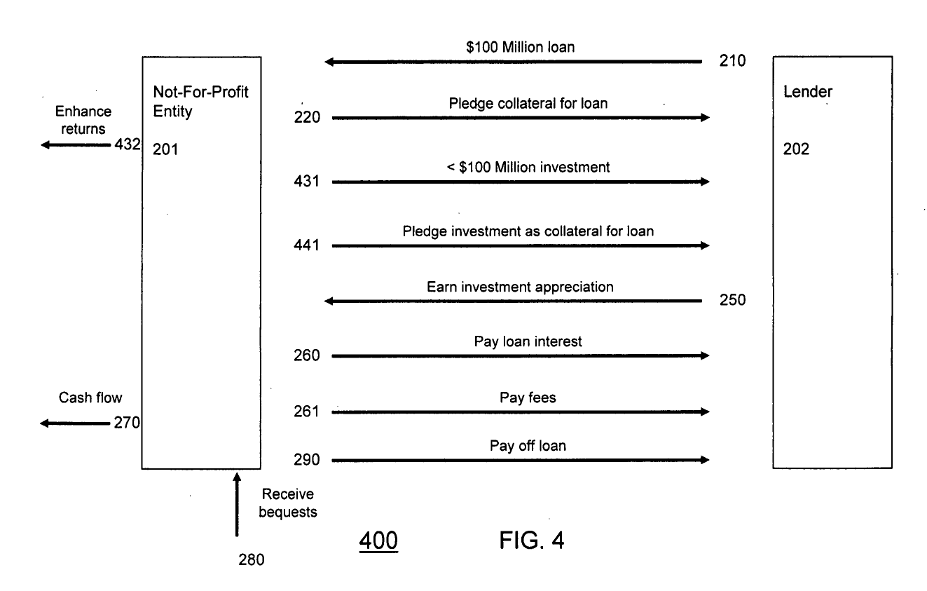

In an alternative embodiment of FIG. 2 that is depicted as a block diagram 400 in FIG. 4, entity 201 does dip into the $100 million in borrowed funds to enhance returns through leverage or for other uses, as indicated by an arrow 432. As an example, entity 201 invest the “dipped into” funds with a third party. In this embodiment, as illustrated by arrows 431 and 441 in FIG. 4, entity 202 invests less than $100 million with lender 202 and pledges that lower investment amount as additional collateral to lender 202. In a different embodiment, entity 201 can also pledge the “dipped into” funds as collateral to lender 202. One skilled in the art understands that the differences between this embodiment of FIG. 4 and the embodiment depicted in FIG. 2 can also be applied to the embodiment depicted in FIG. 3 and its variations.

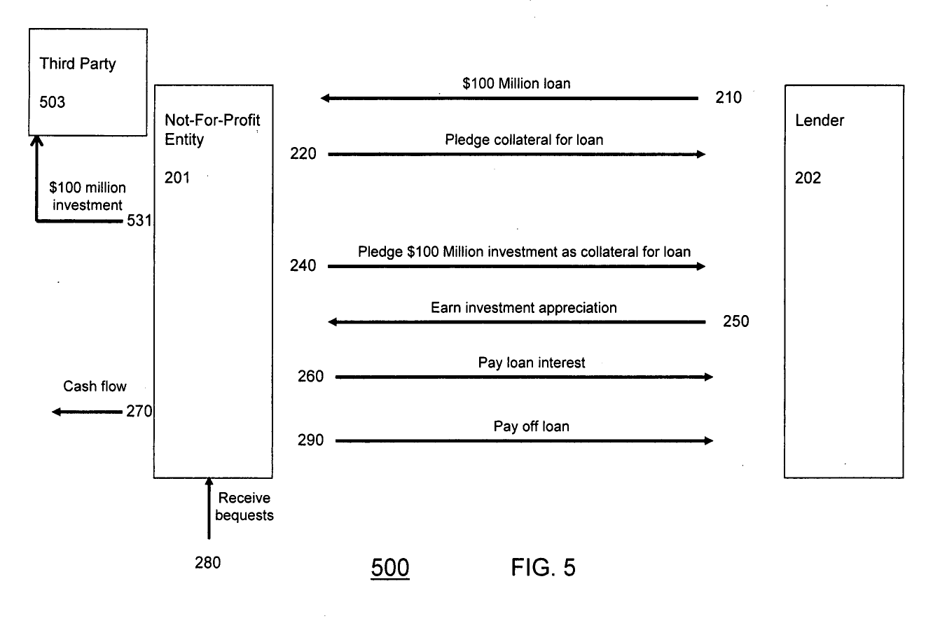

Turning to the next drawing, FIG. 5 depicts another alternative embodiment of FIG. 2. In FIG. 5, a block diagram 500 illustrates entity 201 investing the $100 million loan with a third party 503, as indicated by an arrow 531. In FIG. 5, entity 201 does not invest the $100 million loan with lender 202, as in FIG. 2. One skilled in the art understands that the differences between this embodiment of FIG. 5 and the embodiment depicted in FIG. 2 can also be applied to the embodiments depicted in FIGS. 3 and 4 and their variations.

Returning to the embodiment of FIG. 1, a more detailed example of the terms and conditions of the loan and investment between entity 201 and lender 202 is as follows.

Facility:

An up to $10,000,000 short term loan facility.

Collateral:

Cash Collateral in an amount equal to 102% of the loan amount to be held in a cash or cash equivalents account at lender 202 acceptable in form and type to lender 202 in its sole and absolute discretion.

Pledge of certain of unrestricted donor bequests, including pledges and irrevocable wills, to entity 202, to be considered as secondary collateral.

Expiry Date:

90 days from closing. Extensions may be requested by entity 201 for additional periods and will be provided only- in the sole and absolute discretion of lender 202.

Repayment:

All outstandings are due and payable at the Expiry Date, unless otherwise extended by lender 202 in its sole and absolute discretion.

Upfront Fee:

A due diligence fee of $20,000, payable at closing.

Interest Rate:

Borrowings will bear interest at a per annum rate equal to, at the option of entity 201: The Alternate Base Rate, calculated on the basis of a 365 or 366 day year for so long as the prime rate of lender 202 is applicable, and on the basis of a 360 day year otherwise; or

London inter-bank offer rate (LIBOR) (for interest periods of 1, 2, or 3 months) plus 0.50%, calculated on the basis of a 360 day year; provided, however, that any payment of principal or interest not paid when due would bear interest at a rate per annum (the “Default Rate”) equal to the Alternate Base Rate plus 2.00%.

“Alternate Base Rate” would mean, on any day, the higher of (a) the prime commercial lending rate of lender 202 as publicly announced to be in effect from time to time, or (b) the federal funds rate (as published by the Federal Reserve Bank of New York) plus 0.50%.

Representations and Warranties:

Usual and customary for credit facilities of this size, type and purpose, including such representations and warranties as may be required by lender 202.

Conditions Precedent:

Usual and customary for credit facilities of this size, type, and purpose, and any additional terms or conditions in view of other obligations owed by entity 202.

Covenants:

Usual and customary for credit facilities of this size, type, and purpose, including, but not limited to the following (all covenants to be tested annually with the release of audited financial statements):

1. Maintenance of Cash (defined below) plus current market value of Investments (defined below) to Indebtedness (defined below) of not less than 1.15× at all times and on a pro-forma basis for the immediately preceding fiscal year;

2. Minimum Unrestricted Net Assets (defined below) of $20,000,000 at all times and on a pro-forma basis for the immediately preceding fiscal year;

3. Limitation on the amount of additional indebtedness, guarantees, and contingent liabilities;

4. Delivery of (i) annual financial statements audited by independent public accountants acceptable to lender 202 within 180 days after the end of each fiscal year end, (ii) unaudited quarterly financial statements within 90 days after the end of each fiscal quarter, and (iii) such other financial statements or updates as may be reasonably requested by lender 202, including all notices and statements delivered to a trustee or bond insurer.

Events of Default:

Usual and customary for credit facilities of this size, type, and purpose, including, without limitation, bankruptcy of entity 201 and cross-defaults to other indebtedness of entity 201.

Expenses:

All fees and expenses of lender 202, including, without limitation, all reasonable out-of-pocket fees and expenses of legal counsel to lender 202 in connection with the preparation, negotiation, and closing of, or any amendment or modification to, the loan documentation and the administration of thereof, will be paid by entity 201.

Governing Law:

New York State.

Definitions:

“Cash” means, at any point in time, all cash and cash equivalents held by entity 201, as determined in accordance with the generally accepted accounting principles (GAAP) in a manner consistently applied and as historically applied by entity 201.

“Indebtedness” means with respect to entity 201 (i) any obligation for borrowed money, (ii) any obligation evidenced by a bond, debenture, note, or other similar instrument, (iii) any obligation to pay the deferred purchase price of property or services, other than a trade account payable that arises in the ordinary course of business, (iv) any obligation of entity 201 as lessee under a capital lease, (v) any mandatorily redeemable stock, (vi) any obligation to purchase securities or other property that arises out of or in connection with the sale of the same or substantially similar securities or property, (vii) any non-contingent obligation to reimburse any other person in respect of amounts paid under a letter of credit or other guaranty issued by such other person, (viii) any Indebtedness of others secured by a lien on any asset of entity 201, and (ix) any Indebtedness of others guaranteed by entity 201.

“Investments” means (i) any capital security, evidence of Indebtedness, or other security or instrument issued by any other person, (ii) any loan, advance or extension of credit to (including guaranties of liabilities of), or any contribution to the capital of, any other person, and (iii) any other investment in any other person. An Investment shall be deemed to be “outstanding,” except to the extent that it has been paid or otherwise satisfied in cash or the person making such Investment has received cash in consideration for the sale thereof, notwithstanding the fact that such Investment may otherwise have been forgiven, released, canceled, or otherwise nullified.

“Net Assets” means at any point in time total assets less total liabilities, as determined in accordance with GAAP in a manner consistently applied and as historically applied by entity 201.

“Unrestricted Net Assets” means, at any point in time, all Net Assets held by entity 201 and treated under GAAP in a manner consistently applied and as historically applied by entity 201, as unrestricted and available for general use. Any finds restricted or classified solely by designation of the board of trustees of entity 201 as long-term assets shall be considered unrestricted. Any funds permanently or temporarily restricted by the donor thereof shall be considered restricted.

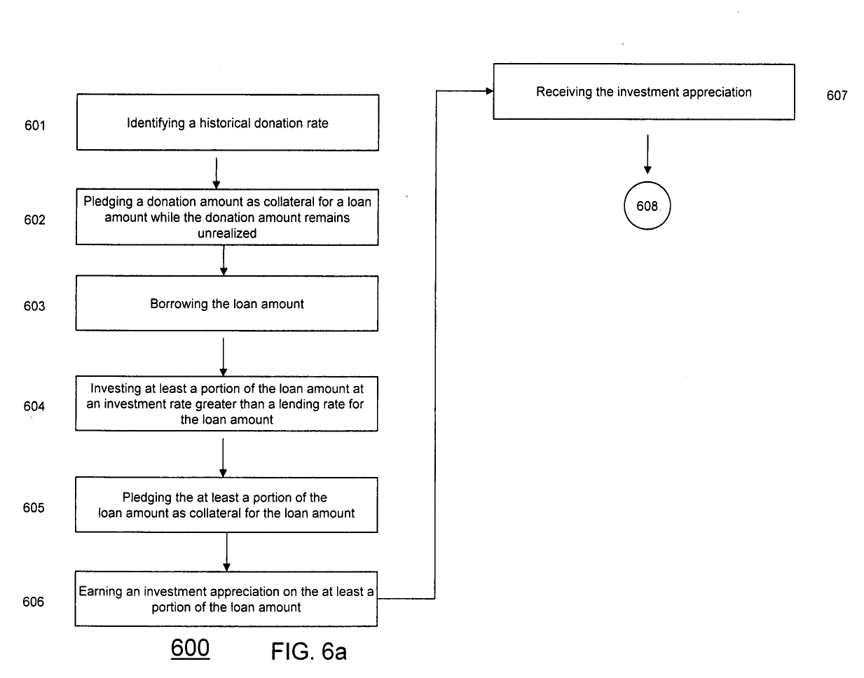

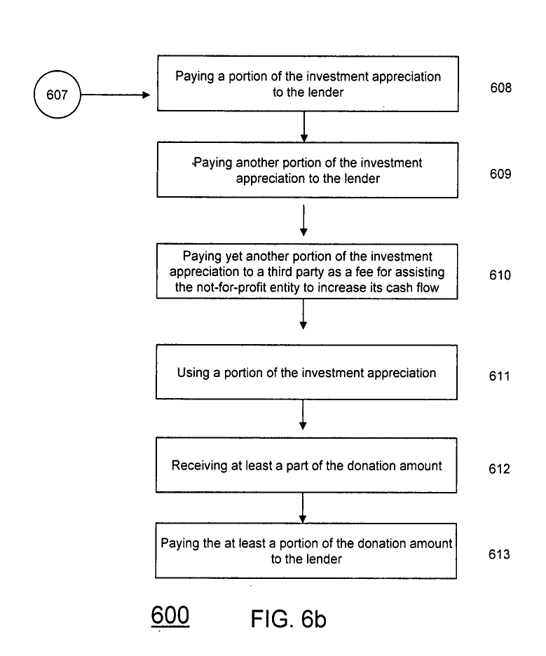

Turning to FIGS. 6a and 6b, a flow chart 600 illustrates, from the perspective of a not-for-profit entity, a method of increasing cash flow for the not-for-profit entity. As an example, the not-for-profit entity of flow chart 600 can be similar to entity 202 in FIGS. 2-5. Flow chart 600 includes a step 601 for identifying a historical donation rate for the not-for-profit entity. As an example, the identifying step can include recognizing, calculating, and/or accepting another's calculation of the historical donation rate. In one embodiment, the historical donation rate can be a historical annual average donation rate. In the same or different embodiment, step 601 can include recognizing the historical donation rate as intangible assets that can be used as collateral or an initial borrowing base. In this embodiment, step 601 can even include convincing a lender that the intangible assets can be used as collateral or an initial borrowing base.

Flow chart 600 also includes a step 602, occurring after step 601, for pledging a donation amount as collateral for a loan amount while the donation amount remains unrealized by the not-for-profit entity. Typically, the not-for-profit entity pledges the collateral to a lender that is loaning the loan amount to the not-for-profit entity. As an example, the lender can be similar to lender 202 in FIGS. 2-5.

Also, the not-for-profit entity expects to receive the donation amount over a period of time such as, for example, a year or more, but the donation amount remains unrealized by the not-for-profit entity during step 602. As explained previously, while the donation amount remains unrealized by the not-for-profit entity, the unrealized donation amount can be expected from one or more non-predetermined sources, can be expected for non-predetermined amounts from the one or more non-predetermined sources, and can be expected to be paid to the not-for-profit entity by the one or more non-predetermined sources at non-predetermined times. Accordingly, in one embodiment of step 602, the donation amount is not considered revenue or income for the not-for-profit entity during step 602. In the same or a different embodiment, the not-for-profit entity considers the donation amount to be an off balance sheet amount while the donation amount is unrealized. In a different embodiment, the donation amounts could be on balance sheet amounts only, or the donation amounts could be both off and on balance sheet amounts (e.g., future bequests and revocable and non-revocable existing bequests, as explained above) for the not-for-profit entity during step 602.

In the same or different embodiment, the loan amount of step 602 is less than the donation amount. For example, the loan amount can be at least a factor of two less than the donation amount to represent a discount for the time value of money and extra protection against the risk of the not-for-profit entity failing to receive any or all of such donation amounts. Additionally, in the same or different embodiment, step 602 can include identifying and/or recognizing the donation amount based on the historical donation rate.

Flow chart 600 also includes a step 603 for borrowing the loan amount from the lender. In one embodiment, step 603 and 602 occur simultaneously with each other such that the not-for-profit entity pledges the collateral to the lender at the outset of the loan. Alternatively, the sequence of steps 602 and 603 can be reversed.

Next, flow chart 600 continues with a step 604 for investing at least a portion of the loan amount at an investment rate greater than a lending rate for the loan amount. As an example, the not-for-profit entity can invest all or part of the loan amount in an investment account with the lender that loaned the not-for-profit entity the loan amount, or the not-for-profit entity can invest all or part of the loan amount in an investment account with a third party. The lending rate can be for interest, fees, or both, and the lending rate can be higher if the not-for-profit entity has a shorter history of reliable bequests and/or if the lender considers the not-for-profit entity as a higher risk for another reason. In one embodiment of step 604, the not-for-profit entity invests all of the loan amount at an investment rate greater than a lending rate for the loan amount.

Flow chart 600 also includes a step 605 for pledging the at least a portion of the loan amount from step 604 as collateral for the loan amount. In one embodiment of step 605, the not-for-profit entity pledges the collateral to the lender. In the same or different embodiment, the not-for-profit entity pledges all of the loan amount that is invested in step 604 as collateral for the loan amount. Step 605 can occur simultaneously with step 604, or their sequence can be reversed.

Next, flow chart 600 continues with a step 606 for earning investment appreciation on the at least a portion of the loan amount. As an example, the investment appreciation can be stock dividends, bond yields, the selling of appreciated real estate, money market fund interest, and/or savings account interest.

After step 606, flow chart 600 continues with steps 607, 608, 609, 610, and 611. In step 607, the not-for-profit entity receives the investment appreciation from the lender or the third party. In step 608, the not-for-profit entity pays a portion of the investment appreciation to the lender. As an example, the not-for-profit entity can pay the loan interest accrued from the loan amount. In step 609, the not-for-profit entity pays another portion of the investment appreciation to the lender. As an example, the not-for-profit entity can pay fees for the loan to the lender. In step 610, the not-for-profit entity pays yet another portion of the investment appreciation to a third party as a fee for assisting the not-for-profit entity to increase its cash flow. As an example, the third party could have introduced the not-for-profit entity and the lender to each other and could have also proposed the present method to both of them. In step 611, the not-for-profit entity uses the remaining portion of the investment appreciation. As an example, the not-for-profit entity uses the remaining portion of the investment appreciation as operating funds.

The sequence of steps 607, 608, 609, 610, and 611 can be varied. As a first example, if the not-for-profit entity borrows the loan amount from the lender and also invests the loan amount with the lender, then the lender may take its loan interest and/or fees from the investment appreciation before paying the remainder of the investment appreciation to the not-for-profit entity. As a second example, the lender may also use the investment appreciation to pay the third party before paying the remainder of the investment appreciation to the not-for-profit entity. As a third example, the sequence of steps 608, 609, and 610 can be reversed. As a fourth example, steps 609 and 610 can be omitted. Additionally, steps 607, 608, 609, 610, and 611 can be repeated in a cycle one or more times.

Next, flow chart 600 continues with a step 612 for receiving at least a part of the donation amount from at least one third party and, then, with a step 613 for paying at least a part of the donation amount to the lender. Step 613 reduces the loan amount and, thus, the loan interest.

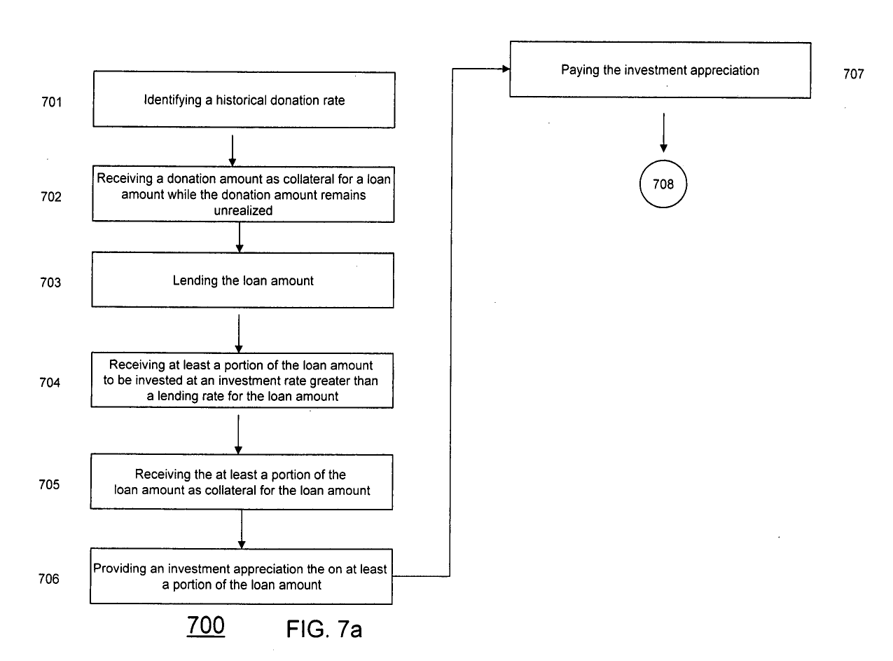

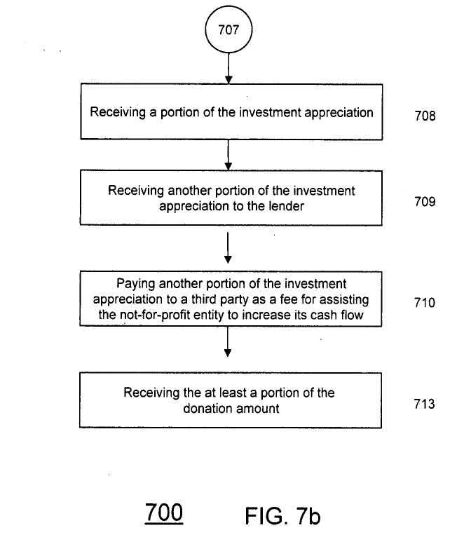

Turning to the next drawing, FIGS. 7a and 7b illustrate a flow chart 700 of a method, from the perspective of a lender, of increasing cash flow for a not-for-profit entity. As an example, the lender of flow chart 700 can be similar to the lender of flow chart 600 in FIGS. 6a and 6b. Additionally, the not-for-profit entity of flow chart 700 can be similar to the not-for-profit entity of flow chart 600 in FIGS. 6a and 6b.

Flow chart 700 includes a step 701 for identifying a historical donation rate for the not-for-profit entity. As an example, step 701 of FIG. 7a can be similar to step 601 of FIG. 6a. Flow chart 700 also includes a step 702, occurring after step 701, for receiving, from the not-for-profit entity, a donation amount as collateral for a loan amount to the not-for-profit entity while the donation amount remains unrealized by the not-for-profit entity. As an example, step 702 of FIG. 7a can be similar to step 602 of FIG. 6a.

Flow chart 700 also includes a step 703 for lending the loan amount to the not-for-profit entity. As an example step 703 of FIG. 7a can be similar to step 603 of FIG. 6a. In one embodiment, steps 703 and 702 occur simultaneously with each other such that the lender receives the collateral to the lender at the outset of the loan. Alternatively, the sequence of steps 702 and 703 can be reversed.

Next, flow chart 700 continues with a step 704 for receiving at least a portion of the loan amount to be invested at an investment rate greater than a lending rate for the loan amount. As an example, step 704 in FIG. 7a can be similar to step 604 in FIG. 6a.

Flow chart 700 also includes a step 705 for receiving the at least a portion of the loan amount from step 704 as collateral for the loan amount. Step 705 can occur simultaneously with step 704, or their sequence can be reversed. As an example, step 705 in FIG. 7a can be similar to step 605 in FIG. 6a.

Next, flow chart 700 continues with a step 706 for providing investment appreciation on the at least a portion of the loan amount of step 705. As an example, step 706 in FIG. 7a can be similar to step 606 in FIG. 6a.

After step 706, flow chart 700 continues with steps 707, 708, 709, and 710, which can be similar to steps 607, 608, 609, and 610, respectively, in FIGS. 6a and 6b. In step 707, the lender pays, transmits, or otherwise provides the investment appreciation to the not-for-profit entity. In step 708, the lender receives a portion of the investment appreciation to pay a loan interest accrued from the loan amount. In step 709, the lender receives another portion of the investment appreciation as fees for the loan amount. In step 710, the lender pays a portion of the investment appreciation to a third party as a fee for assisting the not-for-profit entity to increase its cash flow. The sequence of steps 707, 708, 709, and 710 can be varied in a manner similar to that described previously for steps 607, 608, 609, and 610.

Next, flow chart 700 continues with a step 713 for receiving at least a part of the donation amount from the not-for-profit entity. As an example, step 713 can be similar to step 613 in FIG. 6b.

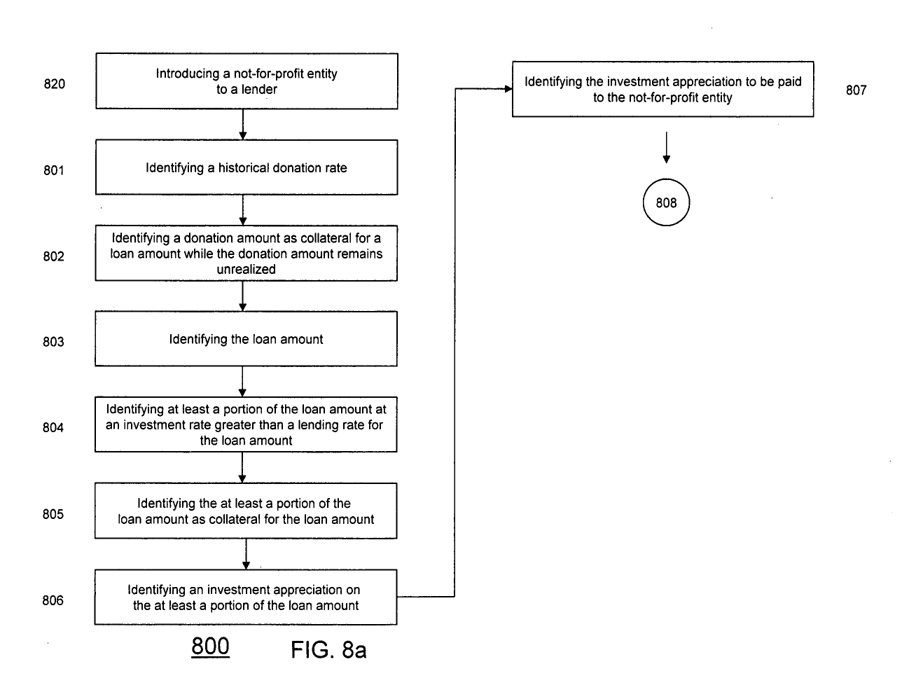

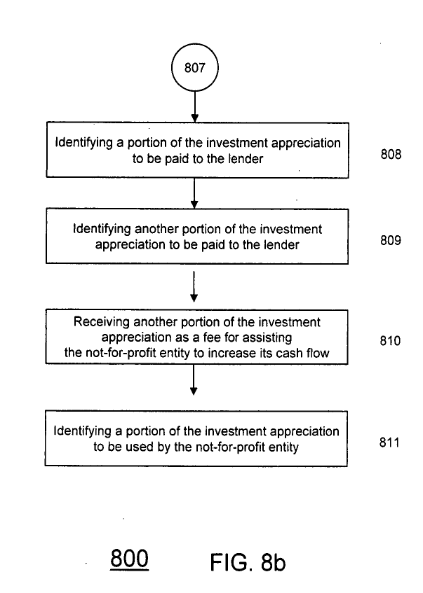

Turning to the next drawing, FIGS. 8a and 8b illustrate a flow chart 800 of a method, from the perspective of an intermediary between a not-for-profit entity and a lender, of increasing cash flow for the not-for-profit entity. As an example, the lender of flow chart 800 can be similar to the lender of flow chart 600 in FIGS. 6a and 6b. Additionally, the not-for-profit entity of flow chart 800 can be similar to the not-for-profit entity of flow chart 600 in FIGS. 6a and 6b.

Flow chart 800 includes a step 820 for introducing the not-for-profit entity to the lender. As an example, the intermediary can introduce the not-for-profit entity and the lender to each other to begin negotiating or otherwise discussing the present method. However, the introduction does not have be a brand new introduction, which means, for example, that the not-for-profit entity and the lender may have had a previous business relationship with each other.

Flow chart 800 continues with a step 801 for recognizing or otherwise identifying a historical donation rate for the not-for-profit entity. As an example, step 801 of FIG. 8a can be similar to step 601 of FIG. 6a. Flow chart 800 also includes a step 802, occurring after step 801, for identifying or otherwise recognizing, from the not-for-profit entity, a donation amount as collateral for a loan amount from the lender to the not-for-profit entity while the donation amount remains unrealized by the not-for-profit entity. As an example, step 802 of FIG. 8a can be similar to step 602 of FIG. 6a.

Flow chart 800 also includes a step 803 for recognizing or otherwise identifying the loan amount from the lender to the not-for-profit entity. As an example step 803 of FIG. 8a can be similar to step 603 of FIG. 6a. In one embodiment, steps 803 and 802 occur simultaneously with each other such that the lender receives the collateral to the lender at the outset of the loan. Alternatively, the sequence of steps 802 and 803 can be reversed.

Next, flow chart 800 continues with a step 804 for recognizing or otherwise identifying at least a portion of the loan amount to be invested at an investment rate greater than a lending rate for the loan amount. As an example, step 804 in FIG. 8a can be similar to step 604 in FIG. 6a.

Flow chart 800 also includes a step 805 for recognizing or otherwise identifying the at least a portion of the loan amount from step 804 as collateral for the loan amount. Step 805 can occur simultaneously with step 804, or their sequence can be reversed. As an example, step 805 in FIG. 8a can be similar to step 605 in FIG. 6a.

Next, flow chart 800 continues with a step 806 for recognizing or otherwise identifying an investment appreciation on the at least a portion of the loan amount of step 805. As an example, step 806 in FIG. 8a can be similar to step 606 in FIG. 6a.

After step 806, flow chart 800 continues with steps 807, 808, 809, 810, and 811, which can be similar to steps 607, 608, 609, 610, and 611, respectively, in FIGS. 6a and 6b. In step 807, the intermediary recognizes or otherwise identifies the investment appreciation to be paid to the not-for-profit entity. In step 808, the intermediary recognizes or otherwise identifies a portion of the investment appreciation to be paid to the lender for the loan interest accrued from the loan amount. In step 809, the intermediary recognizes or otherwise identifies another portion of the investment appreciation to be paid to the lender for fees from the loan amount. In step 810, the intermediary receives a portion of the investment appreciation as a fee for assisting the not-for-profit entity to increase its cash flow. In step 811, the intermediary identifies the remaining portion of the investment appreciation to be used by the not-for-profit entity as operating funds. The sequence of steps 807, 808, 809, 810, and 811 can be varied in a manner similar to that described previously for steps 607, 608, 609, 610, and 611.

Although the invention has been described with reference to specific embodiments, it will be understood by those skilled in the art that various changes may be made without departing from the spirit or scope of the invention. Various examples of such changes have been given in the foregoing description. Accordingly, the disclosure of embodiments of the invention is intended to be illustrative of the scope of the invention and is not intended to be limiting. It is intended that the scope of the invention shall be limited only to the extent required by the appended claims. For example, to one of ordinary skill in the art, it will be readily apparent that, although the method of increasing cash flow for a not-for-profit entity does not require the creation and use of a separate legal entity or a special purpose entity, some embodiments of the method could use such an entity to own or receive the unrealized donation amounts or the invested loan amount. As an additional example, the not-for-profit entity can pay the intermediary up front by using a portion of the loan amount, and this up front payment can be in addition to or in place of the periodic payments from the investment appreciation. As a further example, the processes described herein can include directly securitizing the intangible assets underlying the loan or securitizing the loan using the intangible assets.

What is claimed is:

1. A method of increasing cash flow for a not-for-profit entity, the method comprising the steps of:
pledging a donation amount as collateral for a loan amount while the donation amount remains unrealized by the not-for-profit entity;
investing at least a portion of the loan amount at an investment rate greater than a lending rate for the loan amount; and
pledging the at least a portion of the loan amount as collateral for the loan amount.

2. The method of claim 1 further comprising:
identifying a historical donation rate for the not-for-profit entity,
wherein the step of pledging the donation amount as collateral further comprises identifying the donation amount based on the historical donation rate.

3. The method of claim 1 further comprising:
borrowing the loan amount from a lender,
wherein:
the step of pledging the donation amount as collateral further comprises pledging the donation amount as collateral to the lender;
the step of investing the at least a portion of the loan amount further comprises investing the at least a portion of the loan amount with the lender; and
the step of pledging the at least a portion of the loan amount further comprises pledging the at least a portion of the loan amount as collateral to the lender.

4. The method of claim 1 wherein:
the step of investing the at least a portion of the loan amount further comprises investing all of the loan amount at an investment rate greater than a lending rate for the loan amount; and
the step of pledging the at least a portion of the loan amount further comprises pledging all of the loan amount that is invested at the investment rate greater than the lending rate as collateral for the loan amount.

5. The method of claim 1 further comprising:
earning investment appreciation on the at least a portion of the loan amount;
paying a first portion of the investment appreciation to the lender; and
using the second portion of the investment appreciation.

6. The method of claim 5 further comprising:
paying a third portion of the investment appreciation to a third entity as a fee for assisting the not-for-profit entity to increase its cash flow.

7. The method of claim 1 further comprising:
receiving at least a part of the donation amount from at least one third party; and
paying at least a part of the donation amount to the lender.

8. The method of claim 1 further comprising:
providing the donation amount to be an off balance sheet amount of the not-for-profit entity while the donation amount is unrealized.

9. The method of claim 1 further comprising:
providing the donation amount to comprise:
future bequests that are unidentified as of the pledging step; and
existing bequests that are revocable as of the pledging step.

10. The method of claim 1 further comprising:
while the donation amount remains unrealized by the not-for-profit entity, providing the unrealized donation amount to be from one or more non-predetermined sources, to be non-predetermined amounts from the one or more non-predetermined sources, and to be paid to the not-for-profit entity by the one or more non-predetermined sources at non-predetermined times.

11. A method of increasing cash flow for a not-for-profit entity, the method comprising the steps of:
receiving, from the not-for-profit entity, a donation amount as collateral for a loan amount to the not-for-profit entity while the donation amount remains unrealized by the not-for-profit entity;
receiving at least a portion of the loan amount to be invested at an investment rate greater than a lending rate for the loan amount; and
receiving, as collateral for the loan amount, the at least a portion of the loan amount to be invested at the investment rate greater than the lending rate.

12. The method of claim 11 further comprising:
identifying a historical donation rate for the not-for-profit entity,
wherein the step of receiving, from the not-for-profit entity, the donation amount as collateral further comprises identifying the donation amount based on the historical donation rate.

13. The method of claim 11 further comprising:
loaning the loan amount as a lender to the not-for-profit entity,
wherein:
the step of receiving, as collateral for the loan amount, the at least a portion of the loan amount to be invested further comprises receiving, as collateral for the loan amount, the at least a portion of the loan amount to be invested with the lender.

14. The method of claim 11 wherein:
the step of receiving the at least a portion of the loan amount to be invested further comprises receiving all of the loan amount to be invested at an investment rate greater than a lending rate for the loan amount; and
the step of receiving, as collateral for the loan amount, the at least a portion of the loan amount to be invested at the investment rate greater than the lending rate further comprises receiving, as collateral for the loan amount, all of the loan amount to be invested at the investment rate greater than the lending rate.

15. The method of claim 11 further comprising:
providing investment appreciation for the at least a portion of the loan amount invested at the investment rate;
receiving a first portion of the investment appreciation to pay a loan interest accrued from the loan amount; and
providing a second portion of the investment appreciation to the not-for-profit entity.

16. The method of claim 15 further comprising:
paying a third portion of the investment appreciation to a third entity as a fee for assisting the not-for-profit entity to increase its cash flow.

17. The method of claim 11 further comprising:
receiving at least a part of the donation amount from the not-for-profit entity,
wherein:
the donation amount is an off balance sheet amount for the not-for-profit entity while the at least a part of the donation amount remains unrealized by the not-for-profit entity.

18. A method of increasing cash flow for a not-for-profit entity, the method comprising the steps of:
introducing the not-for-profit entity to a lender;
identifying, from the not-for-profit entity, a donation amount as collateral for a loan amount to the not-for-profit entity while the donation amount remains unrealized by the not-for-profit entity;
identifying at least a portion of the loan amount to be invested at an investment rate greater than a lending rate for the loan amount; and
identifying, as collateral for the loan amount, the at least a portion of the loan amount to be invested at the investment rate greater than the lending rate.

19. The method of claim 18 further comprising:
identifying a historical donation rate for the not-for-profit entity,
wherein the step of identifying, from the not-for-profit entity, the donation amount as collateral further comprises identifying the donation amount based on the historical donation rate.

20. The method of claim 18 wherein:
the step of identifying, from the not-for-profit entity, the donation amount as collateral further comprises identifying the donation amount as collateral to the lender;
the step of identifying the at least a portion of the loan amount to be invested further comprises identifying the at least a portion of the loan amount to be invested with the lender at the investment rate greater than the lending rate; and
the step of identifying, as collateral for the loan amount, the at least a portion of the loan amount to be invested further comprises identifying, as collateral to the lender for the loan amount, the at least a portion of the loan amount to be invested with the lender at the investment rate greater than the lending rate.

21. The method of claim 18 wherein:
the step of identifying the at least a portion of the loan amount to be invested further comprises identifying all of the loan amount to be invested with the lender; and
the step of identifying, as collateral for the loan amount, the at least a portion of the loan amount to be invested further comprises identifying, as collateral for the loan amount, all of the loan amount to be invested at the investment rate greater than the lending rate.

22. The method of claim 18 further comprising:
identifying an investment appreciation on the at least a portion of the loan amount;
identifying a first portion of the investment appreciation to be paid to the lender to pay a loan interest accrued from the loan amount;
identifying a second portion of the investment appreciation to be used by the not-for-profit entity as operating funds.

23. The method of claim 22 further comprising:
receiving a third portion of the investment appreciation.

24. The method of claim 18 further comprising:
receiving a portion of an investment appreciation from the loan amount invested at the investment rate greater than the lending rate.

25. The method of claim 18 further comprising:
receiving a portion of the loan amount.
